(19) United States
(12) Patent Application Publication
(10) Pub. No.: US 2026/0264486 A1
(43) Pub. Date: Sep. 10, 2026

(54) FOLDABLE SUN VISOR

(71) Applicant: Zhiling LIU, Guangzhou (CN)

(72) Inventor: Zhiling LIU, Guangzhou (CN)

(21) Appl. No.: 19/098,395

(22) Filed: Apr. 2, 2025

(30) Foreign Application Priority Data
Mar. 5, 2025 (CN) 2025203823080

(51) Int. Cl. B60J 3/02

(52) U.S. Cl. CPC B60J 3/0278

(57) ABSTRACT

A provided foldable sun visor includes a shade body, with a shape adapted to a shape of an automobile window frame. The shade body includes an aluminum foil surface, partition plates, and a lining surface. The aluminum foil surface and the lining surface are wrapped around outer sides of the partition plates. Multiple groups of folding lines, provided on the shade body, divide the shade body into multiple groups of shade units which stack towards each other in a zigzag manner based on the majority of groups of folding lines, thereby transforming from a flat state to a storage state. The multiple groups folding lines preset enable the shade body to be folded and stored to reduce the area of the shade body. The shape of the shade body after stacking is similar to a long strip, thereby reducing the occupation of interior space of automobile.

### CROSS-REFERENCE TO RELATED APPLICATION

This application claims priority to Chinese Patent Application No. 202520382308.0, filed Mar. 5, 2025, which is herein incorporated by reference in its entirety.

### TECHNICAL FIELD

The disclosure relates to the technical field of automobile sun visors, and more particularly to a foldable sun visor.

### BACKGROUND

Sun visor is mostly used in automobile windows and designed to avoid glare from the sun. It can be moved back and forth to adjust an intensity of sunlight shining into the eyes, thereby improving passenger's riding experience and providing an excellent cooling effect.

However, in related art, most sun visors adopt an integrated structure. Although they possess folding function, they are mostly unfolded using support rods which can reduce an overall area, but still require large interior space in automobile for storage, making it inconvenient for users to carry and store.

### SUMMARY

The disclosure provides a foldable sun visor, aiming to solve the problem that a currently adopted integrated structure of sun visor requires a large interior space in an automobile for storing sun visor, making it inconvenient for users to carry and store.

The disclosure is implemented as follows. A foldable sun visor, includes a shade body and multiple groups of folding lines.

The shade body, with a shape adapted to a shape of automobile window frame, includes an aluminum foil surface, partition plates, and a lining surface. The aluminum foil surface and the lining surface are wrapped around outer sides of the partition plates.

The multiple groups of folding lines are provided on the shade body and divide the shade body into multiple groups of shade units, and the multiple groups of shade units stack towards each other in a zigzag manner based on the multiple groups of folding lines, thereby transforming from a flat state to a storage state.

In an embodiment, the aluminum foil surface and the lining surface are provided with multiple groups of stitching lines arranged in parallel thereon, and the multiple groups of stitching lines are arranged in pairs on both sides of the multiple groups of folding lines.

In an embodiment, the multiple groups of stitching lines divide the aluminum foil surface and the lining surface into multiple groups of chambers independent of each other, the partition plates are placed inside the multiple groups of chambers, and the partition plates in adjacent chambers are not connected to each other.

In an embodiment, the partition plates are provided with creases, positions of the creases correspond to the multiple groups of folding lines, and both sides of each of the creases are connected to the aluminum foil surface and the lining surface through the multiple groups of stitching lines.

In an embodiment, the shade body is provided with magnetic attachment assemblies, each of the magnetic attachment assemblies includes a first magnetic block and a second magnetic block. When the multiple groups of shade units are stacked in a zigzag manner, adjacent shade units of the multiple groups of shade units are magnetically connected through the first magnetic block and the second magnetic block.

In an embodiment, the first magnetic block and the second magnetic block are individually arranged on a corresponding one of the partition plates.

Compared with the related art, the disclosure has the following beneficial technical effects.

The foldable sun visor provided by the disclosure enables the shade body with an integrated structure to be folded and stored through the preset folding lines so as to reduce the area of the shade body. The shape of the shade body after stacking is similar to a long strip, making it convenient for users to carry and store, and reducing and reducing an interior space in the automobile occupied by the foldable sun visor.

### BRIEF DESCRIPTION OF DRAWINGS

FIG. 1 illustrates a schematic structural diagram of a foldable sun visor according to the disclosure.

FIG. 2 illustrates an internal schematic structural diagram of a shade body of the foldable sun visor according to the disclosure.

FIG. 3 illustrates a schematic structural diagram during folding process of the foldable sun visor according to the disclosure.

FIG. 4 illustrates an internal schematic structural diagram of a folding line when partition plates are distributed at intervals in the foldable sun visor according to the disclosure.

FIG. 5 illustrates a schematic structural diagram of an internal structure of the folding line when the partition plates are of an integrated structure in the foldable sun visor according to the disclosure.

FIG. 6 illustrates a schematic structural diagram of magnetic attachment assemblies of the foldable sun visor according to the disclosure.

FIG. 7 illustrates a schematic structural diagram of chambers of the foldable sun visor according to the disclosure.

Description of reference numerals: 100: shade body; 101: shade unit; 102: folding line; 103: chamber; 110: aluminum foil surface; 120: partition plate; 130: lining surface; 140: stitching line; 150: crease; 201: first magnetic block; 201: second magnetic block.

### DETAILED DESCRIPTION OF EMBODIMENTS

Unless otherwise defined, all technical and scientific terms used herein have the same meanings as commonly recognized by those skilled in the art to which the disclosure relates. The terms used in the specification of the disclosure are only for the purpose of describing specific embodiments and are not intended to limit the disclosure. The terms "include" and "have" in the specification and claims of the disclosure and the above-mentioned description of reference numerals, as well as any variations thereof, are intended to cover non-exclusive inclusion. The terms "first" and "second" in the specification and claims of the disclosure and the above-mentioned description of reference numerals are used to distinguish different objects, not to describe a specific order.

Reference to an "embodiment" herein means that specific features, structures, or characteristics described in conjunction with the embodiment may be included in at least one embodiment of the disclosure. The appearance of this phrase at various locations in the specification does not necessarily refer to the same embodiment, nor is it an independent or alternative embodiment mutually exclusive of other embodiments. It is explicitly and implicitly understood by those skilled in the art that the embodiments described herein can be combined with other embodiments.

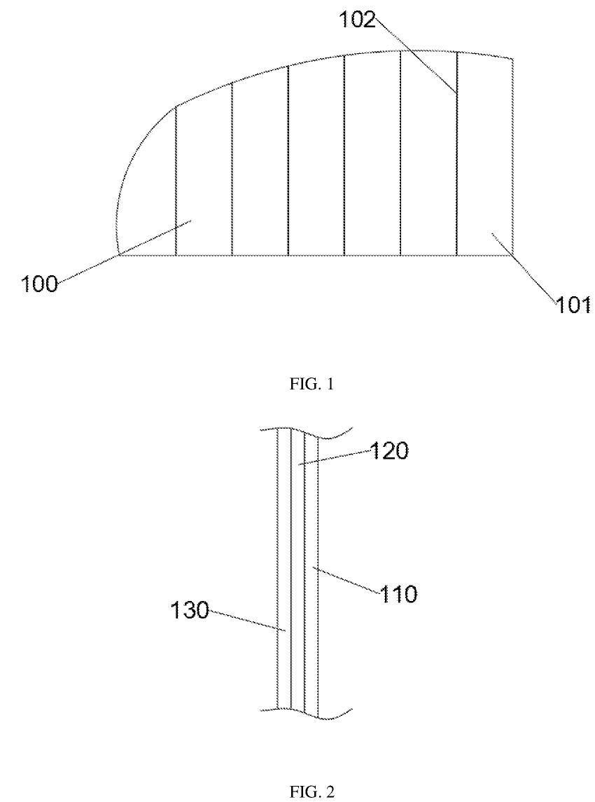

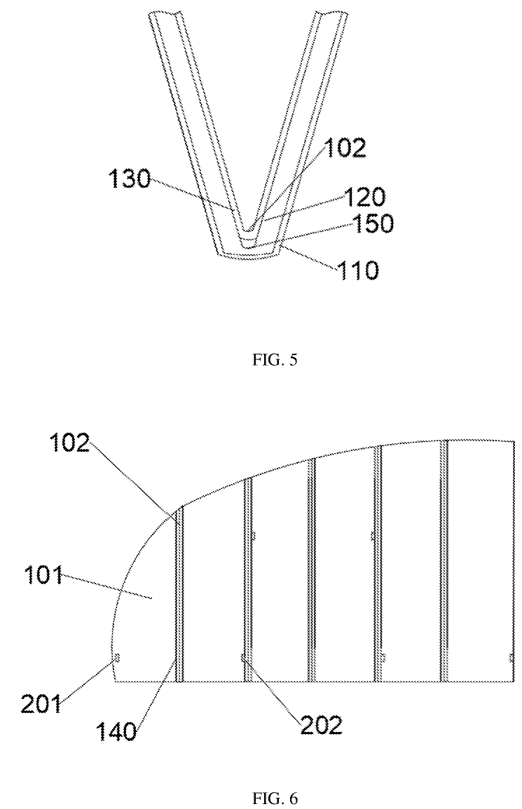

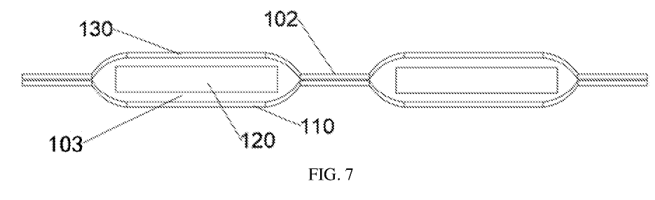

The disclosure provides a foldable sun visor. As illustrated in FIG. 1-FIG. 6, the foldable sun visor is used in an automobile window, and includes a shade body 100 and multiple groups of folding lines 102.

The shade body 100, with a shape adapted to a shape of an automobile window frame, includes an aluminum foil surface 110, partition plates 120, and a lining surface 130.The aluminum foil surface 110 and the lining surface 130 are wrapped around outer sides of the partition plates 120.

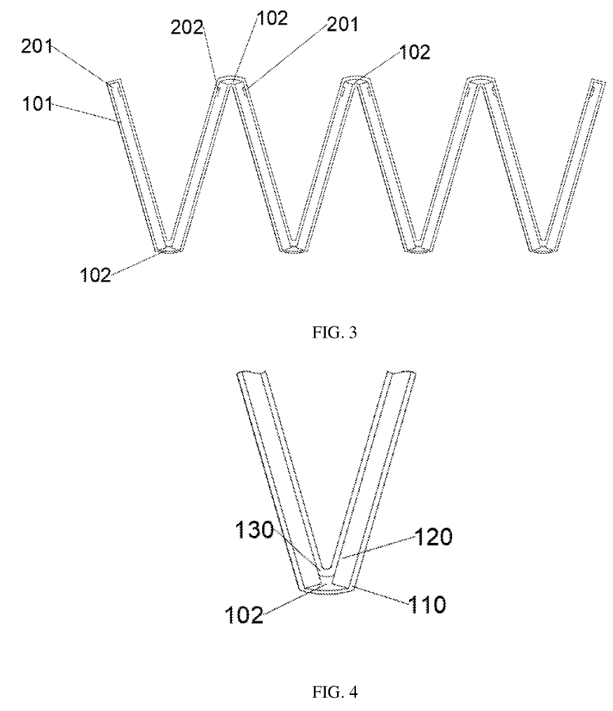

The multiple groups of folding lines 102 are provided on the shade body 100 and divide the shade body 100 into multiple groups of shade units 101. When the multiple groups of shade units 101 are unfolded to form a plane in a flat state, the shade body 100 with the flat state is inserted between the automobile window frame and an automobile glass, thereby completing a shading of the automobile window. As illustrated in FIG. 3, different shade units 101 are bent along different folding lines 102 in a zigzag manner to form a stacked state. The shade body 100 in the stacked state is in a storage state. The shade body 100 with the storage state minimizes an area of the shade body 100 to a greatest extent, thereby making the foldable sun visor convenient for users to place inside an automobile.

In the embodiment, the multiple groups of folding lines 102 preset enable the shade body 100 with an integrated structure to be folded and stored to reduce the area of the shade body 100. The shape of the shade body 100 after stacking is similar to a long strip, thereby making the foldable sun visor convenient for users to carry and store, and reducing an interior space in the automobile occupied by the foldable sun visor.

In an embodiment, the aluminum foil surface 110 and the lining surface 130 are provided with multiple groups of stitching lines 140 arranged in parallel thereon. The multiple groups of stitching lines 140 are arranged in pairs on both sides of the multiple groups of folding lines.

The multiple groups of stitching lines 140 divide the aluminum foil surface 110 and the lining surface 130 into multiple groups chambers 103 independent of each other. The number of the partition plates 120 is multiple groups. The partition plates 120 are independent of each other. The partition plates 120 are placed inside the multiple groups of chambers 103, and the partition plates 120 in adjacent chambers 103 are not connected to each other.

In the embodiment, the multiple groups of stitching lines 140 serve to help form bending lines to facilitate bending. The partition plates 120 adopt independent design and are not connected to each other. The shade body 100 only consists of the aluminum foil surface 110 and the inner lining surface 130 near the multiple groups of folding lines 102, so as to facilitate bending and stacking of the multiple groups of shade units and reduce an influence of thickness of the partition plates 120 during the bending and stacking process of the multiple groups of shade units.

In an embodiment, the aluminum foil surface 110 and the lining surface 130 are provided with multiple groups of stitching lines 140 arranged in parallel thereon. The multiple groups of stitching lines 140 are arranged in pairs on both sides of the multiple groups of folding lines. The partition plates 120 are provided with creases 150, positions of the creases 150 correspond to the multiple groups of folding lines 102 and both sides of each of the creases 150 are connected to the aluminum foil surface 110 and the lining surface 130 through the multiple groups of stitching lines 140.

In the embodiment, the multiple groups of stitching lines 140 serve to help form bending lines to facilitate bending. The partition plates 120 have an integrated structure. With the creases 150 preset on the partition plates 120, the partition plates 120 are folded synchronously during the stacking process of an entire body of the shade body 100. The creases 150 are adopted to reduce a resistance during the bending process of the shade body 100 to facilitate the partition plates 120 to form a folded structure.

In an embodiment, the shade body 100 is provided with magnetic attachment assemblies. Each of the magnetic attachment assemblies include a first magnetic block 201 and a second magnetic block 202. When stacked in the zigzag manner, the multiple groups of shade units 101 are towards each other in pairs. Two adjacent shade units 101 of the multiple groups of shade units 101 towards to each other are magnetically connected through the first magnetic block 201 and the second magnetic block 202. The first magnetic block 201 and the second magnetic block 202 are individually arranged on adjacent shade units 101 of the multiple groups of shade units 101. The first magnetic block 201 and the second magnetic block 202 are specifically arranged on the partition plates 120. Grooves are defined on the partition plate 120 to accommodate the first magnetic block 201 and the second magnetic block 202 respectively.

The arranging positions of the magnetic attachment assemblies need to match with the multiple groups of folding lines 102. When the first magnetic block 201 is arranged near a first group of the multiple groups of folding lines 102, the second magnetic block 202 is arranged near a third group of the multiple groups of folding lines 102. When arranged, the first magnetic block 201 and the second magnetic block 202 need to be separated by one group of the multiple groups of folding lines (i.e., second group of the multiple groups of folding lines 102). The first magnetic block 201 in next group of magnetic attachment assemblies is arranged with the second magnetic block 202 in previous group of magnetic attachment assemblies on both sides of the same group of the multiple groups of folding lines 102, so as to achieve the magnetic connection of the shade units 101 with a folded state.

In addition, a method of hook and loop binding can also be used for storage in addition to the above methods.

It should be noted that, for the aforementioned embodiments, in order to simplify the description, they are all expressed as a series of action combinations, but those skilled in the art should know that the disclosure is not limited by the sequence of the described actions, because according to the disclosure, some steps may be carried out in other sequences or simultaneously. Further, those skilled in the art should also know that the embodiments described in the specification all belong to particular embodiments, and the actions and modules involved are not necessarily required by the disclosure.

The aforementioned embodiments are only used to illustrate the technical solutions of the disclosure and not to limit the scope of protection of the disclosure. Apparently, the described embodiments are only part of the embodiments of the disclosure, not all embodiments. Based on these embodiments, all other embodiments obtained by those skilled in the art without making creative labor fall within the scope of protection of the disclosure. Although the disclosure has been described in detail with reference to the aforementioned embodiments, those skilled in the art can still make combinations, additions, deletions, or other adjustments to the features in each embodiment of the disclosure without making creative labor and without conflict, so as to obtain other technical solutions that are different but essentially do not deviate from the conception of the disclosure, these technical solutions also fall within the scope of protection of the disclosure.

What is claimed is:

1. A foldable sun visor, applied to an automobile window, comprising:
a shade body (100), with a shape adapted to a shape of an automobile window frame, wherein the shade body (100) comprises an aluminum foil surface (110), partition plates (120) and a lining surface (130), the aluminum foil surface (110) and the lining surface (130) are wrapped around outer sides of the partition plates (120); and
a plurality of groups of folding lines (102), provided on the shade body (100), wherein the plurality of groups of folding lines (102) divide the shade body (100) into a plurality of groups of shade units (101), the plurality of groups of shade units (101) stack towards each other in a zigzag manner based on the plurality of groups of folding lines (102), thereby transforming from a flat state to a storage state.

2. The foldable sun visor as claimed in claim 1, wherein the aluminum foil surface (110) and the lining surface (130) are provided with a plurality of groups of stitching lines (140) arranged in parallel thereon, and the plurality of groups of stitching lines (140) are arranged in pairs on both sides of the plurality of groups of folding lines (102).

3. The foldable sun visor as claimed in claim 2, wherein the plurality of groups of stitching lines (140) divide the aluminum foil surface (110) and the lining surface (130) into a plurality of groups of chambers (103) independent of each other, the partition plates (120) are placed inside the plurality of groups of chambers (103), and the partition plates (120) in adjacent chambers (103) are not connected to each other.

4. The foldable sun visor as claimed in claim 2, wherein the partition plates (120) are provided with creases (150), positions of the creases (150) correspond to the plurality of groups of folding lines (102) and both sides of each of the creases (150) are connected to the aluminum foil surface (110) and the lining surface (130) through the plurality of groups of stitching lines (140).

5. The foldable sun visor as claimed in claim 3, wherein the shade body (100) is provided with magnetic attachment assemblies, each of the magnetic attachment assemblies comprises a first magnetic block (201) and a second magnetic block (202), when the plurality of groups of shade units (101) are stacked in the zigzag manner, adjacent shade units (101) of the plurality of groups of shade units (101) are magnetically connected through the first magnetic block (201) and the second magnetic block (202).

6. The foldable sun visor as claimed in claim 5, wherein the first magnetic block (201) and the second magnetic block (202) are individually arranged on a corresponding one of the partition plates (120).
